(19) United States
(12) Patent Application Publication
(10) Pub. No.: US 2025/0230518 A1
(43) Pub. Date: Jul. 17, 2025

(54) HEAT TREATMENT APPARATUS

(71) Applicant: Noritake Co., Limited, Nagoya-shi (JP)

(72) Inventors: Hidenori Nakamura, Nagoya-shi (JP); Hideaki Ohi, Nagoya-shi (JP); Masaki Iida, Nagoya-shi (JP)

(73) Assignee: Noritake Co., Limited, Nagoya-shi (JP)

(21) Appl. No.: 19/017,092

(22) Filed: Jan. 10, 2025

(30) Foreign Application Priority Data
Jan. 11, 2024 (JP) 2024-002838

(51) Int. Cl. C21D 9/573; C21D 9/56; F26B 13/18

(52) U.S. Cl. CPC C21D 9/5735; C21D 9/561; F26B 13/183

(57) ABSTRACT

A heat treatment apparatus includes a furnace body and a cooling device. The furnace body has therein a processing space where a workpiece is heat-treated. The cooling device cools the processing space within the furnace body. The furnace body is provided with a first opening and a second opening. The cooling device includes an inner pipe, an outer pipe, a refrigerant supply unit, and an air supply unit. The inner pipe is provided outside the furnace body. The inner pipe couples the first opening and the second opening. The outer pipe encloses at least a portion of a periphery of the inner pipe. The refrigerant supply unit supplies a refrigerant between the inner pipe and the outer pipe. The air supply unit sends air through the inner pipe from the first opening toward the second opening.

### CROSS REFERENCE TO RELATED APPLICATION(S)

This application claims the benefit of priority to Japanese Patent Application No. 2024-002838 filed on Jan. 11, 2024, the entire contents of which are hereby incorporated herein by reference.

### BACKGROUND OF THE DISCLOSURE

The present disclosure relates to a heat treatment apparatus.

Japanese Patent Publication No. 7285360 discloses a heat treatment apparatus that includes an unwinding unit, a heat treatment unit, a cooling device, and a winding unit. In the heat treatment unit, a strip-shaped workpiece unwound from an unwinding roll provided in the unwinding unit is heat-treated while being conveyed.

### SUMMARY

The present inventors intend to improve the cooling efficiency of the interior of a furnace body after heat-treating a workpiece.

A heat treatment apparatus disclosed herein includes a furnace body and a cooling device. The furnace body has therein a processing space where a workpiece is heat-treated. The cooling device cools the processing space within the furnace body. The furnace body is provided with a first opening and a second opening. The cooling device includes an inner pipe, an outer pipe, a refrigerant supply unit, and an air supply unit. The inner pipe is provided outside the furnace body. The inner pipe couples the first opening and the second opening. The outer pipe encloses at least a portion of a periphery of the inner pipe. The refrigerant supply unit supplies a refrigerant between the inner pipe and the outer pipe. The air supply unit sends air through the inner pipe from the first opening toward the second opening. With this configuration, the heat treatment apparatus improves the cooling efficiency of the interior of the furnace body after heat-treating the workpiece.

### BRIEF DESCRIPTION OF THE DRAWINGS

FIG. 1 is a schematic diagram illustrating a heat treatment apparatus 10.

FIG. 2 is a cross-sectional view of a heat treatment unit 40.

FIG. 3 is a schematic diagram of the heat treatment unit 40.

### DETAILED DESCRIPTION OF THE INVENTION

One embodiment in the present disclosure will be described in detail below with reference to the drawings. In the following drawings, members and portions that have the same actions are denoted by the same symbols. The dimensional relationships (length, width, thickness, etc.) in each drawing do not reflect the actual dimensional relationships. The directions of up, down, left, right, front, and back are represented are represented by arrows U, D, L, R, F, and Rr, respectively, in the figures. Here, the directions of up, down, left, right, front, and back are only provided for convenience of explanation and do not limit the present disclosure unless otherwise specifically mentioned.

### Heat Treatment Apparatus 10

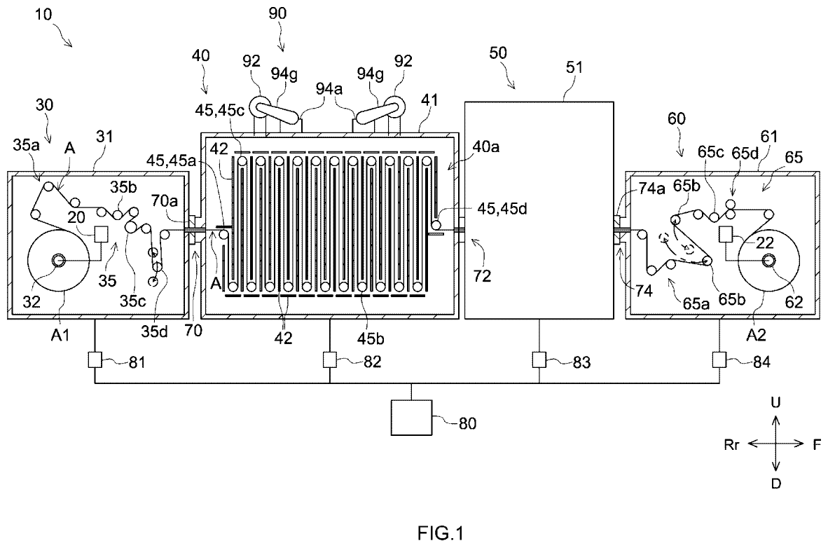

FIG. 1 is a schematic diagram illustrating a heat treatment apparatus 10. The heat treatment apparatus 10 is equipment for performing heat treatment on a strip-shaped (sheet-shaped) workpiece A, which is an object to be processed. In this embodiment, the heat treatment apparatus 10 is a device for continuously drying a strip-shaped workpiece while conveying it in a so-called roll-to-roll system. The workpiece A is not particularly limited as long as it is a strip-shaped object, such as an electrode sheet for secondary batteries that has an electrode material applied to both sides of a sheet base, a Flexible Copper Clad Laminate (FCCL), or a polyimide sheet. The heat treatment apparatus 10 can be used to perform the treatment on a variety of strip-shaped (sheet-shaped) workpieces.

The heat treatment apparatus disclosed herein is not limited to a roll-to-roll type apparatus that performs heat treatment on a strip-shaped workpiece A, but can be applied to various types of heat treatment apparatuses. The configuration of the heat treatment apparatus disclosed herein can be applied to, for example, a so-called roller hearth kiln in which a workpiece is conveyed by a plurality of conveyance rollers arranged along a conveyance direction. The configuration of the heat treatment apparatus disclosed herein is not limited to the roll-to-roll type heat treatment apparatus or a continuous type heat treatment apparatus such as the roller hearth kiln. The configuration of the heat treatment apparatus disclosed herein can also be applied to a so-called batch-type heat treatment apparatus in which a workpiece is heat-treated in a stationary standing state within a furnace.

As illustrated in FIG. 1, the heat treatment apparatus 10 includes an unwinding unit 30, a heat treatment unit 40, a cooling unit 50, and a winding unit 60.

The strip-shaped workpiece A is processed while being conveyed, through the unwinding unit 30, the heat treatment unit 40, the cooling unit 50, and the winding unit 60 in that order. The workpiece A is unwound from an unwinding roll A1 provided in the unwinding unit 30, heat-treated in the heat treatment unit 40, cooled in the cooling unit 50, and then wound onto a winding roll A2 provided in the winding unit 60.

### Conveyance Devices 20 and 22

Conveyance devices 20 and 22 are devices that convey the workpiece A. The workpiece A is conveyed along a predetermined conveyance route. The conveyance devices 20 and 22 are devices that rotationally drive an unwinding shaft 32, on which the unwinding roll A1 of the unwinding unit 30 is attached, and a winding shaft 62, on which the winding roll A2 of the winding unit 60 is attached, respectively. Each of the conveyance devices 20 and 22 can be constituted of a device that controls the conveyance of the workpiece A. For example, a motor and an inverter may be used as the conveyance devices 20 and 22, and particularly a servo motor or the like may be used.

The conveyance devices 20 and 22 may include a device that controls a tension applied to the workpiece A. For example, a powder clutch may be used as the device for controlling the tension. The conveyance devices 20 and 22 may be implemented by a system in which a device for controlling the conveyance speed and a device for controlling the tension cooperate with each other.

The unwinding shaft 32 is connected to the conveyance device 20. The unwinding shaft 32 is rotationally driven by the conveyance device 20, thereby unwinding the workpiece A from the unwinding roll A1. The winding shaft 62 is connected to the conveyance device 22. The winding shaft 62 is rotationally driven by the conveyance device 22, thereby winding the workpiece A onto the winding roll A2. The conveyance devices 20 and 22 may be installed in an atmospheric box provided in a space enclosed by outer walls 31 and 61, respectively. The conveyance devices 20 and 22 may be provided outside the outer walls 31 and 61, respectively.

The heat treatment apparatus 10 can be configured to convey the workpiece A at a high speed in order to improve the processing efficiency of the workpiece A. Although not particularly limited, the conveyance speed of the workpiece A can be set to about 1 m/min to 200 m/min. In this embodiment, the conveyance speed of the workpiece A is set to about 100 m/min.

In the heat treatment apparatus 10, the conveyance speed of the workpiece A is controlled by a controller (not illustrated).

The controller controls the conveyance speed of the workpiece A, the tension applied to the workpiece A, and the like such that the workpiece A is conveyed according to a predetermined conveyance condition. The controller respectively controls an unwinding tension applied when the workpiece A is unwound, an in-furnace tension applied to the workpiece A being processed, and a winding tension applied when the processed workpiece A is wound up. The controller is connected to the conveyance devices 20 and 22. The controller may be connected to a tension detection roller 35b, a feed roller 35c, a dancer roller 35d, a tension detection roller 65c, and the like. The controller feeds back the unwinding tension detected by the tension detection roller 35b to the conveyance device 20 and thereby controls the torque of the unwinding shaft 32. Thus, the unwinding tension is adjusted. The controller also feeds back, to the dancer roller 35d, the in-furnace tension detected by the tension detection roller 35b, over which the workpiece A being processed is hung. The dancer roller 35d moves according to the detected in-furnace tension. Thus, the in-furnace tension is adjusted. The rotation speed of the feed roller 35c is controlled such that the position of the dancer roller 35d returns to a reference position with the in-furnace tension being constant. The controller feeds back the winding tension detected by the tension detection roller 65c to the conveyance device 22 and thereby controls the torque of the winding shaft 62. Thus, the winding tension is adjusted.

### Unwinding Unit 30

The unwinding unit 30 is equipment that unwinds the workpiece A. The unwinding unit 30 houses the unwinding roll A1 in a state where the workpiece A before the heat treatment is wound thereon.

The unwinding unit 30 has the outer wall 31 that encloses internal equipment and the unwinding roll A1. The unwinding unit 30 includes therein the unwinding shaft 32 and plural rollers 35. The unwinding shaft 32 is a shaft to which the unwinding roll A1, holding the workpiece A wound on it before heat treatment, is attached. In this embodiment, the unwinding shaft 32 is rotationally driven to unwind the workpiece A from the unwinding roll A1 attached to the unwinding shaft 32.

Within the space enclosed by the outer wall 31 of the unwinding unit 30, the plural rollers 35 that set the conveyance route for the workpiece A are provided. The workpiece A unwound from the unwinding roll Al is hung around and sequentially passed through the plural rollers 35 in a predetermined order and then conveyed toward the heat treatment unit 40.

The plural rollers 35 include guide rollers 35a, the tension detection roller 35b, the feed roller 35c, and the dancer roller 35d. The tension detection roller 35b is a roller for detecting the tension applied to the workpiece A. A tension detector (not illustrated) is attached to the tension detection roller 35b. The dancer roller 35d is configured to be movable within a predetermined range. By moving the dancer roller 35d, the tension applied to the workpiece A is adjusted. The feed roller 35c is rotationally driven by a drive device (not illustrated). By controlling the rotation of the feed roller 35c, the position of the dancer roller 35d is adjusted.

### Heat Treatment Unit 40

The heat treatment unit 40 is equipment where the strip-shaped workpiece A is heat-treated while being conveyed. The heat treatment unit 40 is connected to the unwinding unit 30 via a connecting part 70. The connecting part 70 is provided with an outlet for the unwinding unit 30 and an inlet for the heat treatment unit 40. A path through which the workpiece A passes is formed in the connecting part 70. The workpiece A is conveyed from the unwinding unit 30 to the heat treatment unit 40 through the connecting part 70. The path for the workpiece A formed in the connecting part 70 is set to have dimensions slightly larger than the width and thickness of the workpiece A. This reduces the likelihood of interference between the atmosphere of the heat treatment unit 40 and that of the unwinding unit 30.

The heat treatment unit 40 includes an outer wall 41 (furnace body 41), heaters 42, and guide rollers 45 (45a to 45d). The outer wall 41 has therein a processing space 40a where the workpiece A is processed while being conveyed. The outer wall 41 encloses the processing space 40a in which the heaters 42 and the guide rollers 45 are arranged.

### Guide Rollers 45

The guide rollers 45 are provided within the processing space 40a. The guide roller 45 is a roller that guides the workpiece A. The conveyance route along which the workpiece A is conveyed is set by the guide rollers 45. The guide roller 45 is configured to rotate in a driven manner as the workpiece A is conveyed. In this embodiment, each guide roller 45 is a substantially cylindrical roller. A guide roller 45a is provided near the inlet (connecting part 70) of the heat treatment unit 40. Plural guide rollers 45b are arranged at a predetermined pitch from the inlet to an outlet in a lower portion of the heat treatment unit 40. Plural guide rollers 45c are arranged in an upper portion of the heat treatment unit 40 while being offset by half a pitch from the plural guide rollers 45b. The guide roller 45d is provided near an outlet (connecting part 72) of the heat treatment unit 40.

The workpiece A is hung on the guide roller 45a near the inlet of the heat treatment unit 40 and conveyed downward. Thereafter, the workpiece A is alternately hung around the upper and lower guide rollers 45b and 45c in sequence from the inlet toward the outlet. Thus, in the heat treatment unit 40, the workpiece A moves vertically up and down as it progresses from the inlet to the outlet.

### Heater 42

The heater 42 is equipment for heating the workpiece A. In this embodiment, the heaters 42 are arranged around the workpiece A which progresses from the inlet to the outlet, in a way that appears to fold up and down. The heater 42 is also arranged in each gap between portions of the workpiece A, which is folded up and down while being hung over the guide rollers 45b and 45c. Each heater 42 is arranged to face the workpiece A. The heater 42 may be fixed, for example, by a heater holder or a support.

In this embodiment, a far-infrared heating type plate heater is used as the heater 42. Various types of heaters may be used as the heater 42, depending on the heating temperature, heating atmosphere, and the like. For example, a cylindrical heater may be used as the heater 42, in addition to the plate heater. The material of the heater 42 is not particularly limited, and a metal sheath heater, a ceramic heater, a lamp heater, or the like may be used. The heater 42 is not limited to the far-infrared heating type heater. In the case of an atmospheric furnace, for example, a hot-air heating type heater that blows hot air onto a workpiece or an infrared heating type lamp heater may be used as the heater 42. The heat-treated workpiece A is conveyed out toward the cooling unit 50 through the guide roller 45d provided near the outlet.

### Cooling Unit 50

The cooling unit 50 is equipment in which the workpiece A heat-treated in the heat treatment unit 40 is cooled while being conveyed. The cooling unit 50 is connected to the heat treatment unit 40 via the connecting part 72. The connecting part 72 is provided with the outlet for the heat treatment unit 40 and an inlet for the cooling unit 50.

Although a detailed illustration is omitted, the cooling unit 50 may include a cooling roller, plural guide rollers, and an outer wall 51. The cooling unit 50 may be provided with plural cooling rollers. The outer wall 51 encloses a processing space in which the plural cooling rollers and the plural guide rollers are disposed. The plural cooling rollers and the plural guide rollers set a conveyance route along which the workpiece A is conveyed in the cooling unit 50.

The cooling roller is a roller configured to allow the circulation of a refrigerant. The workpiece A is cooled by contacting a surface of the cooling roller. The cooling roller may be connected to a drive device (not illustrated). The cooling roller can rotate along the conveyance direction at a set conveyance speed.

In this embodiment, the workpiece A is cooled to about room temperature in the cooling unit 50. The temperature to which the workpiece A is cooled is not particularly limited. Note that the configuration of the cooling unit 50, including the guide rollers, the cooling rollers, and the like, is not particularly limited.

The cooled workpiece A is conveyed to the winding unit 60 through a connecting part 74. The cooling unit 50 does not necessarily have to be provided in the heat treatment apparatus 10.

The cooling unit 50 is connected to the winding unit 60 via the connecting part 74. The connecting part 74 includes an outlet for the cooling unit 50 and an inlet for the winding unit 60. The cooled workpiece A is conveyed to the winding unit 60 through the connecting part 74.

### Winding Unit 60

The winding unit 60 is equipment that winds up the workpiece A. The winding unit 60 houses the winding roll A2 for winding up the workpiece A that has been cooled through the cooling unit 50.

The winding unit 60 includes the outer wall 61 surrounding internal equipment and the winding roll A2. The winding unit 60 includes the winding shaft 62 and plural rollers 65. The winding roll A2 is attached to the winding shaft 62, and the workpiece A, which has been heat-treated in the heat treatment unit 40 and cooled in the cooling unit 50, is wound onto the winding roll A2. By rotationally driving the winding shaft 62, the workpiece A is wound onto the winding roll A2.

Within the space enclosed by the outer wall 61 of the winding unit 60, the plural rollers 65 that set the conveyance route for the workpiece A are provided. The plural rollers 65 set the conveyance route along which the workpiece A is conveyed within the winding unit 60. The workpiece A conveyed from the cooling unit 50 is hung over the roller 65 near the inlet (connecting part 74) of the winding unit 60, then hung around the plural rollers 65 in the predetermined order, and eventually wound onto the winding roll A2. The plural rollers 65 include guide rollers 65a, a dancer roller 65b, the tension detection roller 65c, and feed rollers 65d. The dancer roller 65b is configured to be movable within a predetermined range. The dancer roller 65b can be moved, for example, to secure a necessary extra length of the workpiece A when the winding roll A2 is replaced. A tension detector (not illustrated) is attached to the tension detection roller 65c. The feed roller 65d feeds out the necessary extra length of the workpiece A when the workpiece A is attached to a new winding roll A2 after the replacement of the winding roll A2.

### Vacuum Pump 80

The heat treatment apparatus 10 includes a vacuum pump 80. Interior spaces of the unwinding unit 30, the heat treatment unit 40, the cooling unit 50, and the winding unit 60 described above are enclosed by the outer walls 31, 41, 51, and 61, respectively. The unwinding unit 30, the heat treatment unit 40, the cooling unit 50, and the winding unit 60 have spaces isolated from an external space by the outer walls 31, 41, 51, and 61, respectively. The spaces inside the outer walls 31, 41, 51, and 61 communicate with each other when the workpiece A is processed. The vacuum pump 80 is connected to the outer walls 31, 41, 51, and 61 of the respective units.

The vacuum pump 80 reduces the pressure in the spaces inside the unwinding unit 30, the heat treatment unit 40, the cooling unit 50, and the winding unit 60 (the processing spaces 40a in the heat treatment unit 40). In this embodiment, the workpiece A is processed under a predetermined vacuum atmosphere that has a pressure lower than atmospheric pressure.

The connection form of the vacuum pump 80 is not particularly limited. Plural vacuum pumps 80 may be provided, and the respective vacuum pumps 80 may be connected to the unwinding unit 30, the heat treatment unit 40, the cooling unit 50, and the winding unit 60. Alternatively, pipes may be branched from one vacuum pump 80 to reduce the pressure inside some of the unwinding unit 30, the heat treatment unit 40, the cooling unit 50, and the winding unit 60.

The pipe of the vacuum pump 80 is provided with vacuum valves 81 to 84 for adjusting the vacuum level in each unit. The furnace body 41 is connected to an atmospheric release valve 85 that exposes the processing space 40a to the atmosphere.

The vacuum valves 81 to 84 are configured to be switchable between the connection of each unit to the vacuum pump 80 and the disconnection of each unit from the vacuum pump 80. In a case where the vacuum level of each unit is not adjusted, open/close valves may be used instead of the vacuum valves 81 to 84.

A door 70a is provided at the inlet of the heat treatment unit 40 (in this embodiment, the connecting part 70). The door 70a is closed when replacing the unwinding roll A1 or the like. By closing the door 70a when replacing the unwinding roll A1 or the like, the atmosphere of the heat treatment unit 40 (in this embodiment, a reduced pressure state) can be maintained. The door 70a may be closed when the workpiece A passes through the connecting part 70, such as when the unwinding roll A1 is replaced. When the remaining workpiece A on the unwinding roll A1 is nearly depleted, the unwinding roll A1 is replaced with a new one. The end of a workpiece A on the newly installed unwinding roll A1 after the replacement and the end of the workpiece A from the previous roll before the replacement are joined together. With the workpiece A remaining in the processing space 40a, the unwinding roll A1 can be replaced while maintaining the atmosphere in the heat treatment unit 40, allowing for a quick recovery of the apparatus after the replacement of the unwinding roll A1.

A door 74a is provided at the outlet of the cooling unit 50 (in this embodiment, the connecting part 74). Like the door 70a, the door 74a can maintain the atmosphere (in this embodiment, the reduced pressure state) in the cooling unit 50 by closing the door 74a when replacing the winding roll A2 or the like. The door 74a may be closed when the workpiece A passes through the connecting part 74, such as when the winding roll A2 is replaced. When the amount of workpiece A wound on the winding roll A2 becomes significant, the winding roll A2 is replaced with a new one. A leading edge of the newly installed winding roll A2 after the replacement and the end of the workpiece A are joined together. With the workpiece A remaining in the processing space, the winding roll A2 can be replaced while maintaining the atmosphere in the cooling unit 50, allowing for a quick recovery of the apparatus after the replacement of the winding roll A2.

The heat treatment apparatus is shut down after the heat treatment of the workpiece is completed. Upon shutdown, the temperature inside the furnace body is lowered. When the temperature inside the furnace body remains high for a long time, any equipment inside the furnace body may deteriorate. In addition, the prolonged high temperature in the furnace body tends to accelerate deterioration of a member for maintaining the atmosphere inside the furnace body (e.g., a seal material provided on a door of the furnace body). The heat treatment apparatus disclosed herein will be described using the configuration of a heat treatment unit 40 of the heat treatment apparatus 10 described above as an example.

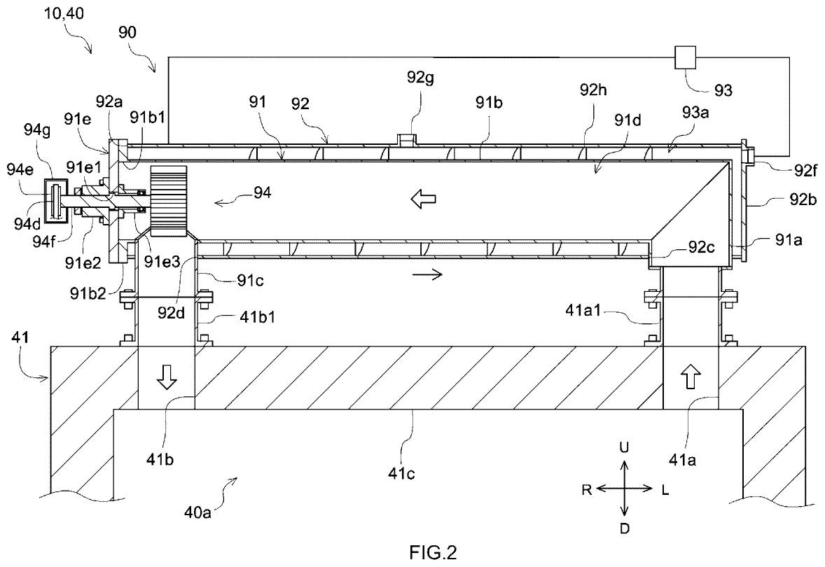

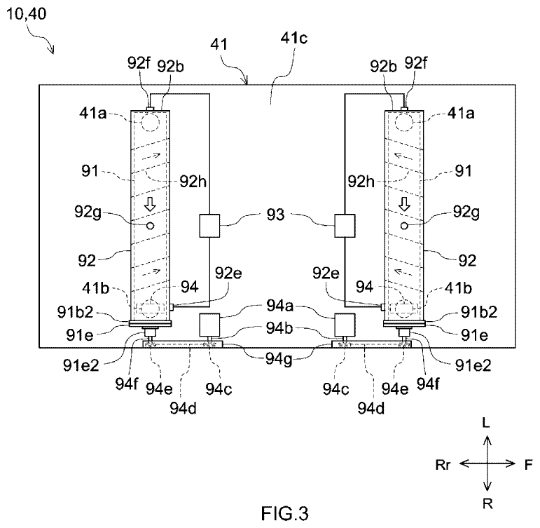

FIG. 2 is a cross-sectional view of the heat treatment unit 40. Specifically, FIG. 2 schematically illustrates the cross-section of an upper portion of the heat treatment unit 40 as viewed from the front toward the rear. FIG. 3 is a schematic diagram of the heat treatment unit 40. Specifically, FIG. 3 schematically illustrates the plane of the heat treatment unit 40 as viewed from above. In FIGS. 2 and 3, the direction in which the refrigerant flows is indicated by arrows, while the direction in which air flows is indicated by hollow arrows.

The heat treatment apparatus 10 includes the furnace body 41 and a cooling device 90. In this embodiment, the furnace body 41 and the cooling device 90 are provided in the heat treatment unit 40.

The furnace body 41 has a substantially rectangular parallelepiped shape. The furnace body 41 has therein the processing space 40a where the workpiece A is heat-treated. Heaters 42, guide rollers 45, and the like are provided in the processing space 40a inside the furnace body 41 (see FIG. 1). The processing space 40a may be provided with a member to support the heater 42, the guide rollers 45, or the like. The furnace body 41 is not particularly limited as long as it can block the atmosphere inside. The furnace body 41 may be made of a metal plate (such as a stainless steel plate) having a required thickness. The furnace body 41 may include a heat insulating material. The furnace body 41 may have its inner surface made of the heat insulating material and its outer surface made of a metal plate.

The material, thickness, and the like of the configuration of the furnace body 41 are set as appropriate according to a processing temperature of a target workpiece A and the like.

As illustrated in FIG. 2, the furnace body 41 is provided with a first opening 41a and a second opening 41b. In this embodiment, the first opening 41a and the second opening 41b are formed in a ceiling portion 41c of the furnace body 41. The first opening 41a and the second opening 41b penetrate the ceiling portion 41c of the furnace body 41. The first opening 41a is formed at a left end portion of the furnace body 41. The second opening 41b is formed at a right end portion of the furnace body 41. However, the positions at which the first opening 41a and the second opening 41b are formed are not particularly limited. The first opening 41a and the second opening 41b may be connected to the center of the ceiling portion 41c. The first opening 41a and the second opening 41b may be formed at any position of the furnace body 41 other than the ceiling portion 41c, such as a side portion of the furnace body 41. The cooling device 90 is connected to the first opening 41a and the second opening 41b.

### Cooling Device 90

The cooling device 90 cools the processing space 40a within the furnace body 41. The cooling device 90 is activated when the heat treatment apparatus is shut down, such as after the heating treatment of the workpiece A, to lower the temperature inside the furnace body 41. Although not particularly limited, the temperature inside the furnace body 41 can be lowered to about room temperature. The cooling device 90 can be operated after the heat treatment of the workpiece A and the turning-off of the heater 42. The cooling device 90 includes an inner pipe 91, an outer pipe 92, a refrigerant supply unit 93 (see FIG. 3), and an air supply unit 94. In this embodiment, the furnace body 41 has two cooling devices 90 provided in the front-back direction (see FIG. 3). The number of cooling devices 90 required is not particularly limited, since the required number of cooling devices 90 varies depending on the dimensions of the furnace body 41, the cooling capacity of the cooling device 90, and the like.

### Inner Pipe 91

The inner pipe 91 is a pipe provided outside the furnace body 41. In this embodiment, the inner pipe 91 is a pipe having a substantially U shape. The cross-section of the inner pipe 91 is substantially circular. The inner pipe 91 has a first portion 91a, a second portion 91b, and a third portion 91c. The first portion 91a is a portion extending in the height direction on the left side of the furnace body 41. The third portion 91c is a portion extending in the height direction on the right side of the furnace body 41. The second portion 91b is a portion coupling the first portion 91a and the third portion 91c. The first portion 91a and the third portion 91c have substantially the same length. The first portion 91a and the third portion 91c are shorter than the second portion 91b. However, the shape, dimensions, and the like of the inner pipe 91 are not particularly limited.

In this embodiment, an upper part of the first portion 91a is larger in diameter than a lower part of the first portion 91a. An upper end of the first portion 91a is coupled to a left end of the second portion 91b in a substantially L-shape. The second portion 91b extends along the width direction of the furnace body 41. An opening 91b1 of a substantially circular shape is formed at a right end of the second portion 91b. At the opened right end of the second portion 91b, a flange portion 91b2 is provided that expands in an outer diameter direction. A lid 91e is attached to the flange portion 91b2 from its right side. The opening 91b1 is closed by the lid 91e. The third portion 91c extends downward from a side surface of the second portion 91b in the vicinity of the flange portion 91b2. The diameter of the third portion 91c is smaller than that of the second portion 91b. The diameter of each of the first portion 91a to the third portion 91c can be designed according to the position and dimensions of the air supply unit 94, the diameters of the openings 41a and 41b, and the like.

The inner pipe 91 is connected to the furnace body 41 via a pipe 41a1 extending upward from the first opening 41a and a pipe 41b1 extending upward from the second opening 41b. A lower end of the first portion 91a is connected to an upper end of the pipe 41a1. A lower end of the third portion 91c is connected to the upper end of the pipe 41a1. The inner pipe 91 couples the first opening 41a and the second opening 41b. Here, the inner pipe 91 couples the first opening 41a and the second opening 41b via the pipes 41a1 and 41b1. An internal space 91d of the inner pipe 91 is coupled to the processing space 40a in the furnace body 41 via the first opening 41a, the second opening 41b and the pipes 41a1 and 41b1. The inner pipe 91 is enclosed by the outer pipe 92.

### Outer Pipe 92

The outer pipe 92 is a pipe that encloses at least a portion of a periphery of the inner pipe 91. The outer pipe 92 encloses the second portion 91b of the inner pipe 91 in the circumferential direction. The diameter of the outer pipe 92 is larger than the diameter of the second portion 91b of the inner pipe 91. In this embodiment, the outer pipe 92 and the second portion 91b of the inner pipe 91 constitute a double pipe. The outer diameter of the outer pipe 92 is smaller than the outer diameter of the flange portion 91b2 of the inner pipe 91. A right end portion 92a of the outer pipe 92 is connected to the flange portion 91b2 of the inner pipe 91. The outer pipe 92 extends from the inner surface of the flange portion 91b2 of the inner pipe 91 along the width direction of the furnace body 41. The outer pipe 92 is longer than the inner pipe 91. A left end portion 92b of the outer pipe 92 has a substantially circular shape. The left end portion 92b of the outer pipe 92 is located outside the first portion 91a of the inner pipe 91.

The inner pipe 91 penetrates a lower portion of the outer pipe 92. Here, the first portion 91a and the third portion 91c of the inner pipe 91 penetrate a lower portion 92c on the left side and a lower portion 92d on the right side of the outer pipe 92, respectively. The lower portion 92c on the left side of the outer pipe 92 is connected to a side circumferential surface of the first portion 91a. The lower portion 92d on the right side of the outer pipe 92 is connected to a circumferential side surface of the third portion 91c. An internal space 93a is formed between the outer pipe 92 and the inner pipe 91. The internal space 93a is separated from the internal space 91d of the inner pipe 91 and the processing space 40a in the furnace body 41.

As illustrated in FIG. 3, the outer pipe 92 is provided with a supply port 92e and a discharge port 92f. The outer pipe 92 may be provided with a degassing port 92g. The degassing port 92g is formed at the center of the outer pipe 92 in the axial direction. The degassing port 92g is formed in a position where it is opened upward. The supply port 92e is provided on a right outer circumferential surface of the outer pipe 92. The supply port 92e is provided at the end portion of the outer pipe 92 in the front-back direction. The supply port 92e is provided at the substantially center of the outer pipe 92 in the height direction. The discharge port 92f is provided at the left end portion 92b of the outer pipe 92. The discharge port 92f is provided at an upper portion of the left end portion 92b (see FIG. 2). The discharge port 92f is provided at a position higher than the supply port 92e. In this embodiment, the supply port 92e and the discharge port 92f are connected to the refrigerant supply unit 93. A refrigerant is supplied into the interior space 93a by the refrigerant supply unit 93 (see FIG. 3).

### Refrigerant Supply Unit 93

The refrigerant supply unit 93 is a device that supplies a refrigerant between the inner pipe 91 and the outer pipe 92. The refrigerant supply unit 93 is not particularly limited, as long as it can supply a refrigerant into the space (the internal space 93a) between the inner pipe 91 and the outer pipe 92. In this embodiment, a device, called a chiller, which allows the circulation of a refrigerant at a preset temperature, is used as the refrigerant supply unit 93. The temperature of the refrigerant supplied to the interior space 93a is lower than the ambient temperature of the processing space 40a, such as room temperature or a temperature lower than room temperature. Although not particularly limited, water or the like can be used as the refrigerant. The refrigerant supply unit 93 is disposed outside the furnace body 41.

The refrigerant supply unit 93 allows the circulation of the refrigerant using a pump. The refrigerant supply unit 93 is connected to the supply port 92e and the discharge port 92f of the outer pipe 92 via a hose, a joint, or the like. The refrigerant supply unit 93 supplies the refrigerant to the supply port 92e and discharges the refrigerant from the discharge port 92f, using the pump. The refrigerant supply unit 93 supplies the refrigerant from the right side to the left side of the outer pipe 92. The refrigerant is cooled to the preset temperature by heat exchange within the refrigerant supply unit 93 and circulates in the space between the refrigerant supply unit 93 and each of the inner pipe 91 and the outer pipe 92. The outer circumferential surface of the inner pipe 91 is cooled with the refrigerant. Consequently, the internal space 91d of the inner pipe 91 is cooled. Air is sent to the internal space 91d of the inner pipe 91 by the air supply unit 94.

### Air Supply Unit 94

The air supply unit 94 is a device that sends air through the inner pipe 91 from the first opening 41a toward the second opening 41b. The air supply unit 94 is not particularly limited, as long as it can supply the air into the inner pipe 91. In this embodiment, the air supply unit 94 is provided in the internal space 91d of the inner pipe 91. The air supply unit 94 is provided above the second opening 41b. A sirocco fan is used as the air supply unit 94. By using the sirocco fan as the air supply unit 94, a large amount of air can be supplied to the inner pipe 91 with a compact structure of the air supply unit 94. The air supply unit 94 is not limited to a sirocco fan, but a propeller fan, a turbo fan, or the like may also be used. The air supply unit 94 sends the air from the first opening 41a toward the second opening 41b, thereby allowing the air to circulate in the processing space 40a of the furnace body 41 and in the internal space 91d of the inner pipe 91.

The air supply unit 94 is driven by an electric motor 94a. For example, a servo motor can be used as the electric motor 94a. The air supply unit 94 is driven by the electric motor 94a via shafts 94b and 94f, pulleys 94c and 94e and a belt 94d. The shaft 94b extends from the electric motor 94a. The pulley 94c is connected to the shaft 94b. The pulley 94c is connected to the pulley 94e via the belt 94d. The pulley 94c and the belt 94d may be housed in a cover 94g. The pulley 94e is positioned where the rotational axis of the pulley 94e is aligned with the rotational axis of the air supply unit 94. The pulley 94e is connected to the air supply unit 94 via the shaft 94f. However, a drive mechanism for the air supply unit 94 is not limited to the form described above. For example, the electric motor 94a (motor) may be directly connected to the air supply unit 94 without a belt or the like.

As illustrated in FIG. 2, the pulley 94e is connected to one end of the shaft 94f, and the air supply unit 94 is connected to the other end thereof. The shaft 94f is inserted into a through hole 91e1 formed in the lid 91e. A magnetic seal 91e2 is provided on an outer surface of the lid 91e. The magnetic seal 91e2 blocks the internal space 91d of the inner pipe 91 from the outside. A support member 91e3 that supports the shaft 94f is attached to an inner surface of the lid 91e. The support member 91e3 has a bearing. The shaft 94f is rotatably supported via the bearing. The electric motor 94a rotationally drives blades of the air supply unit 94 (in this embodiment, a sirocco fan). This creates the flow of air in the interior space 91d.

In the embodiment described above, the heat treatment apparatus 10 includes the furnace body 41 and the cooling device 90. The furnace body 41 has therein the processing space 40a where the workpiece A is heat-treated. The cooling device 90 cools the processing space 40a within the furnace body 41. The furnace body 41 is provided with the first opening 41a and the second opening 41b. The cooling device 90 includes the inner pipe 91, the outer pipe 92, the refrigerant supply unit 93, and the air supply unit 94. The inner pipe 91 is provided outside the furnace body 41. The inner pipe 91 couples the first opening 41a and the second opening 41b. The outer pipe 92 encloses at least a portion of the periphery of the inner pipe 91. The refrigerant supply unit 93 supplies the refrigerant between the inner pipe 91 and the outer pipe 92. The air supply unit 94 sends air through the inner pipe 91 from the first opening 41a toward the second opening 41b.

In the heat treatment apparatus 10, air is sent from the first opening 41a toward the second opening 41b by the air supply unit 94 in the space inside the inner pipe 91 when the apparatus is shut down. This circulates the atmosphere in the space inside the inner pipe 91 and in the processing space 40a of the furnace body 41. In the heat treatment apparatus 10, the refrigerant is supplied between the inner pipe 91 and the outer pipe 92 by the refrigerant supply unit 93. Consequently, the inner pipe 91 is cooled. The atmosphere in the processing space 40a is supplied into the inner pipe 91 through the first opening 41a. By cooling the inner pipe 91, the air passing through the inner pipe 91 is cooled. The air cooled in the inner pipe 91 is supplied from the second opening 41b to the processing space 40a of the furnace body 41. The atmosphere circulates in the processing space of the furnace body 41 and the space (inner space 91d) inside the inner pipe 91 while being cooled in the inner pipe 91. Thus, the processing space 40a of the furnace body 41 is cooled down quickly after the heat treatment apparatus 10 is shut down. In other words, in the heat treatment apparatus 10, the cooling efficiency of the processing space 40a of the furnace body 41 is improved. By quickly lowering the temperature in the furnace body 41, deterioration of a member for maintaining the atmosphere inside the furnace body 41 (e.g., sealing material provided on the door of the furnace body) and the like can be reduced.

The heat treatment apparatus 10 includes the vacuum pump 80 that reduces the pressure in the processing space 40a within the furnace body 41. In a vacuum state, no convection flow occurs within the processing space 40a, which results in a prolonged cooling time of the furnace body 41. In this embodiment, the furnace body 41 is connected to the atmospheric release valve 85 that exposes the processing space 40a to the atmosphere. When the heat treatment apparatus 10 is shut down, the atmospheric release valve 85 can be opened. After the atmospheric release valve 85 is opened, the air cooled with the refrigerant is allowed to circulate in the processing space 40a of the furnace body 41, as described above. Thus, the cooling efficiency of the processing space 40a can be improved also in the heat treatment apparatus 10 including the vacuum pump 80.

In the embodiment described above, the first opening 41a and the second opening 41b are formed in the ceiling portion 41c of the furnace body 41. In the processing space 40a, the air with a higher temperature tends to accumulate more easily as it gets closer to the ceiling portion 41c. The cooling efficiency of the air can be improved by the formation of the first opening 41a and the second opening 41b in the ceiling portion 41c of the furnace body 41.

As illustrated in FIG. 2, the air supply unit 94 sends air from the first opening 41a toward the second opening 41b of the inner pipe 91. Consequently, the air flows from left to right within the inner pipe 91. In contrast, the refrigerant supply unit 93 supplies the refrigerant from the supply port 92e (see FIG. 3) toward the discharge port 92f. Consequently, the refrigerant flows from right to left between the inner pipe 91 and the outer pipe 92. In other words, the refrigerant supply unit 93 supplies the refrigerant between the inner pipe 91 and the outer pipe 92 in a direction opposite to the direction in which the air is sent into the inner pipe 91. The cooling efficiency of the inner pipe 91 is improved by setting the direction of sending the air opposite to the direction of supplying the refrigerant.

Here, the direction in which the refrigerant is supplied is defined by a direction thereof from the supply port 92e to the discharge port 92f. Note that the direction in which air is sent and the direction in which the refrigerant is supplied do not necessarily have to be opposite directions, but may be substantially the same.

In the embodiment described above, the discharge port 92f is located at a position higher than the supply port 92e. Thus, the space between the inner pipe 91 and the outer pipe 92 can be easily filled with the refrigerant. As a result, the cooling efficiency of the air circulating in the space inside the inner pipe 91 and the processing space 40a can be improved. Furthermore, the discharge port 92f may be provided at a position higher than the upper end of the inner pipe 91.

A flow path for the refrigerant is not particularly limited as long as it can cool the inner pipe 91.

In this embodiment, as illustrated in FIGS. 2 and 3, a screw vane 92h is provided between the inner pipe 91 and the outer pipe 92. The screw vane 92h is wound in a spiral manner along the outer circumferential surface of the inner pipe 91 and the inner circumferential surface of the outer pipe 92. Thus, the flow path through which the refrigerant flows in the spiral manner is formed between the inner pipe 91 and the outer pipe 92. With this configuration, a circulation route through which the refrigerant flows between the inner pipe 91 and the outer pipe 92 becomes longer, making it possible to improve the cooling efficiency of the inner pipe 91. As a result, the cooling efficiency of the air passing through the inner pipe 91 can also be improved.

The interior of the inner pipe 91 may be provided with a plate that adjusts the flow path for the air supplied by the air supply unit 94. Within the inner pipe 91, a plate that inhibits air from flowing linearly along the inner pipe 91 may be provided. For example, a spiral plate may be provided on the inner circumferential surface of the inner pipe 91. Thus, the flow path for the air can be formed along the spiral plate. The spiral plate can be provided on an inner circumferential surface of the second portion 91b. The provision of the spiral plate on the inner circumferential surface of the inner pipe 91 may disrupt the flow of air supplied by the air supply unit 94. This can extend the residence time of the air in the inner pipe 91, thereby improving the cooling efficiency of the air. In addition, the heat transfer area of heat from the refrigerant can be increased by causing the air to easily contact the inner circumferential surface of the inner pipe 91. As a result, the cooling efficiency of the air can be improved.

The above is a detailed description of the technology disclosed herein through the specific embodiments, but those are illustrative only and do not limit the scope of the claims.

Accordingly, the technology described in claims includes various variations and modifications of the embodiments described above.

The present specification also includes the following Items 1 to 7. The following items 1 to 7 are not limited to the above embodiments.

Item 1:
1. A heat treatment apparatus, including:
a furnace body having therein a processing space where a workpiece is heat-treated; and
a cooling device that cools the processing space within the furnace body, wherein
the furnace body is provided with a first opening and a second opening, and
the cooling device includes:
an inner pipe provided outside the furnace body and coupling the first opening and the second opening;
an outer pipe enclosing at least a portion of a periphery of the inner pipe;
a refrigerant supply unit that supplies a refrigerant between the inner pipe and the outer pipe; and
an air supply unit that sends air through the inner pipe from the first opening toward the second opening.

Item 2:

The heat treatment apparatus according to Item 1, wherein the refrigerant supply unit supplies the refrigerant between the inner pipe and the outer pipe in a direction opposite to a direction in which the air is sent into the inner pipe.

Item 3:

The heat treatment apparatus according to Item 1 or 2, wherein a flow path through which the refrigerant flows in a spiral manner is formed between the inner pipe and the outer pipe.

Item 4:

The heat treatment apparatus according to any one of Items 1 to 3, wherein the first opening and the second opening are formed in a ceiling portion of the furnace body.

Item 5:

The heat treatment apparatus according to any one of Items 1 to 4, further including: a vacuum pump that reduces pressure in the processing space within the furnace body, wherein an atmospheric release valve that exposes the processing space to atmosphere is connected to the furnace body.

Item 6:

The heat treatment apparatus according to any one of Items 1 to 5, further including: the outer pipe is provided with a supply port through which the refrigerant is supplied and a discharge port through which the refrigerant is discharged, and the discharge port is provided at a position higher than the supply port.

Item 7:

The heat treatment apparatus according to any one of Items 1 to 6, wherein a plate that adjusts a flow path for air is provided within the inner pipe.

What is claimed is:

1. A heat treatment apparatus, comprising:
a furnace body having therein a processing space where a workpiece is heat-treated; and
a cooling device that cools the processing space within the furnace body, wherein
the furnace body is provided with a first opening and a second opening, and
the cooling device comprises:
an inner pipe provided outside the furnace body and coupling the first opening and the second opening;
an outer pipe enclosing at least a portion of a periphery of the inner pipe;
a refrigerant supply unit that supplies a refrigerant between the inner pipe and the outer pipe; and
an air supply unit that sends air through the inner pipe from the first opening toward the second opening.

2. The heat treatment apparatus according to claim 1, wherein the refrigerant supply unit supplies the refrigerant between the inner pipe and the outer pipe in a direction opposite to a direction in which the air is sent into the inner pipe.

3. The heat treatment apparatus according to claim 1, wherein a flow path through which the refrigerant flows in a spiral manner is formed between the inner pipe and the outer pipe.

4. The heat treatment apparatus according to claim 1, wherein the first opening and the second opening are formed in a ceiling portion of the furnace body.

5. The heat treatment apparatus according to claim 1, further comprising:
a vacuum pump that reduces pressure in the processing space within the furnace body, wherein
an atmospheric release valve that exposes the processing space to atmosphere is connected to the furnace body.

6. The heat treatment apparatus according to claim 1, wherein
the outer pipe is provided with a supply port through which the refrigerant is supplied and a discharge port through which the refrigerant is discharged, and
the discharge port is provided at a position higher than the supply port.

7. The heat treatment apparatus according to claim 1, wherein a plate that adjusts a flow path for air is provided within the inner pipe.
